(19) United States
(12) Patent Application Publication
(10) Pub. No.: US 2013/0015626 A1
(43) Pub. Date: Jan. 17, 2013

(54) SEALING STRUCTURE FOR INTEGRATED HYDRAULIC CONTROL SYSTEM AND INTEGRATED HYDRAULIC CONTROL SYSTEM WITH THE SAME

(71) Applicants: Yong Kap Kim, Gyeonggi-do (KR); Dong Yo Ryu, Dongjak-gu (KR)

(72) Inventors: Yong Kap Kim, Gyeonggi-do (KR); Dong Yo Ryu, Dongjak-gu (KR)

(73) Assignee: MANDO CORPORATION

(21) Appl. No.: 13/547,975

(22) Filed: Jul. 12, 2012

(30) Foreign Application Priority Data
Jul. 12, 2011 (KR) 10-2011-0068726

(51) Int. Cl. F16L 21/00

(52) U.S. Cl. 277/607

(57) ABSTRACT

Disclosed herein is a sealing structure for an integrated hydraulic control system to integrate a first hydraulic control system to control brake hydraulic pressure, the first hydraulic control system having a modulator block, in which the hydraulic pressure line to supply brake hydraulic pressure to wheel cylinders of a vehicle is formed, and a second hydraulic control system connected to the first hydraulic control system, wherein the first and second hydraulic control systems are coupled to each other each other in a surface contact fashion such that the hydraulic pressure line formed in the modulator block of the first hydraulic control system communicates with a hydraulic pressure line formed in a modulator block of the second hydraulic control system to form at least one through channel, and a hollow channel connection seal to block leakage of the brake hydraulic pressure outside is provided in the through channel.

### CROSS-REFERENCE TO RELATED APPLICATION(S)

This application claims the benefit of Korean Patent Application No. 2011-0068726, filed on Jul. 12, 2011 in the Korean Intellectual Property Office, the disclosure of which is incorporated herein by reference.

### BACKGROUND

1. Field

Embodiments of the present invention relate to a sealing structure for an integrated hydraulic control system that integrates different hydraulic control systems to control brake hydraulic pressure through a simply structure and an integrated hydraulic control system with the same.

2. Description of the Related Art

Generally, a vehicle includes a brake, and an electronic control brake system is used to improve the performance of the brake. The electronic control brake system supplies or controls brake hydraulic pressure generated by pedal force of a brake pedal through various control systems according to purposes to provide strong and stable braking force.

For example, an anti-lock brake system (ABS) to prevent slippage of wheels when braking a vehicle, a brake traction control system (BTCS) to prevent slippage of driving wheels when a vehicle is abruptly started or is abruptly accelerated, and a vehicle dynamic control system (VDC) or electronic stability control (ESC) configured by combining the anti-lock brake system and the brake traction control system to control brake liquid pressure so that a travelling state of a vehicle is stably maintained, are disclosed as the electronic control brake system.

In addition, an active hydraulic booster (AHB) to control brake hydraulic pressure, an electro hydraulic brake system (EHB) configured to have all functions of the anti-lock brake system, the brake traction control system, and the vehicle dynamic control system, and a hydraulic power unit (HPU) are disclosed.

In the above-mentioned electronic control brake systems, one hydraulic control system to control brake hydraulic pressure or a plurality of hydraulic control systems to control brake hydraulic pressure is mounted in a vehicle in a state in which the hydraulic control systems are connected to each other.

The hydraulic control system includes a plurality of solenoid valves to control brake hydraulic pressure transmitted to wheel cylinders mounted to wheels of a vehicle, a pair of low-pressure and high-pressure accumulators to temporarily store oil, a motor and pump to forcibly pump the oil temporarily stored in the low-pressure accumulator, and an electrical control unit (ECU) to control driving of the solenoid valves and the motor.

Since valve assemblies of the solenoid valves, the pump, and the low-pressure and high-pressure accumulators are mounted in a cuboidal modulator block, which is made of aluminum, all hydraulic pressure lines are connected to the modulator block to constitute a circuit. For this reason, the modulator block is provided with a plurality of ports connected to the wheel cylinders to supply brake hydraulic pressure generated by pedal force of a brake pedal to the wheel cylinders. The ports include inlet ports to introduce brake hydraulic pressure and outlet ports to discharge the brake hydraulic pressure.

In a case in which the hydraulic control systems are connected to each other, liquid pressure pipes are connected to the respective ports using a standard tool. For example, as shown in FIGS. 1 and 2, a first hydraulic control system 10 and a second hydraulic control system 20 are connected to each other by liquid pressure pipes 30.

One of the above-mentioned electronic control brake systems may be used as the first hydraulic control system 10 or the second hydraulic control system 20. However, the same electronic control brake system is not used as the first hydraulic control system 10 and the second hydraulic control system 20. The first hydraulic control system 10 is connected to a brake pedal 1, and the second hydraulic control system 20 is connected to wheel cylinders 2 of wheels.

More specifically, one end of each of the liquid pressure pipes 30 is connected to a corresponding one of the outlet ports 12 of the first hydraulic control system 10, and the other end of each of the liquid pressure pipes 30 is connected to a corresponding one of the inlet ports 22 of the second hydraulic control system 20. Since high-pressure brake oil flows in the liquid pressure pipes 30, nuts 33 are mounted to opposite ends of each of the liquid pressure pipes 30 to prevent leakage of the oil, and the opposite ends of each of the liquid pressure pipes 30 are coupled to the hydraulic control systems 10 and 20 by caulking. Unexplained reference numeral 11 indicates a modulator block of the first hydraulic control system 10, and 21 indicates a modulator block of the second hydraulic control system 20.

However, the size of an integrated hydraulic control system is increased by the liquid pressure pipes 30 connecting the hydraulic control systems 10 and 20 when integrating the hydraulic control systems 10 and 20 with the result that it may be difficult to design an installation space. Also, if the liquid pressure pipes 30 are damaged due to external impact, brake hydraulic pressure is not smoothly supplied to the wheel cylinders 2 with the result that an accident may occur.

### SUMMARY

Therefore, it is an aspect of the present invention to provide a sealing structure for an integrated hydraulic control system including a channel connection seal to couple different hydraulic control systems in a contact fashion and to prevent leakage of brake hydraulic pressure from contact regions of the hydraulic control systems, thereby improving installation space utilization of the integrated hydraulic control system and an integrated hydraulic control system with the same.

Additional aspects of the invention will be set forth in part in the description which follows and, in part, will be obvious from the description, or may be learned by practice of the invention.

In accordance with one aspect of the present invention, a sealing structure for an integrated hydraulic control system integrates a first hydraulic control system to control brake hydraulic pressure, the first hydraulic control system having a modulator block, in which the hydraulic pressure line to supply brake hydraulic pressure to wheel cylinders of a vehicle is formed, and a second hydraulic control system connected to the first hydraulic control system, wherein the first and second hydraulic control systems are coupled to each other each other in a surface contact fashion such that the hydraulic pressure line formed in the modulator block of the first hydraulic control system communicates with a hydraulic pressure line formed in a modulator block of the second hydraulic control system to form at least one through channel, and a hollow channel connection seal to block leakage of the brake hydraulic pressure outside is provided in the through channel.

The modulator blocks of the first and second hydraulic control systems, in which the through channel is formed, may be provided with bores formed to extend the through channel, and the channel connection seal may be forcibly fitted in the bores formed in the first hydraulic control system and/or the bores formed in the second hydraulic control system.

The channel connection seal may be provided at the outer circumference thereof with a stopper protruding in a radial direction to prevent the channel connection seal from being moved by the brake hydraulic pressure.

The channel connection seal may have elastic force and may be manufactured by injection molding.

The channel connection seal may be formed in a lip-type shape to resist internal pressure.

The channel connection seal may include a metallic main body having a groove formed at the outer circumference thereof, and the sealing structure may further include a sealing member and a backup ring fitted in the groove.

The sealing member and the backup ring may be located in one of the modulator blocks of the first and second hydraulic control systems in a state in which the channel connection seal is coupled to the through channel.

In accordance with another aspect of the present invention, an integrated hydraulic control system includes a first hydraulic control system including a first modulator block having a first hydraulic pressure line formed therein, the first modulator block being provided at the outside thereof with a plurality of first bores connected to the first hydraulic pressure line, a second hydraulic control system including a second modulator block having a second hydraulic pressure line formed therein, the second modulator block being provided at the outside thereof with a plurality of second bores connected to the second hydraulic pressure line, the second hydraulic control systems being coupled to the first hydraulic control system in a surface contact fashion such that the first hydraulic pressure line and the second hydraulic pressure line communicate with each other to form at least one through channel, and a channel connection seal including a first coupling part coupled to the first bores of the first modulator block in which the through channel is formed to block leakage of brake hydraulic pressure outside and a second coupling part coupled to the second bores of the second modulator block, the channel connection seal having a hollow part formed therein in a longitudinal direction such that the hollow part communicates with the through channel, wherein the first coupling part and/or the second coupling part of the channel connection seal is forcibly fitted in the first bores and/or the second bores.

The channel connection seal may be provided at the outer circumference thereof with a stopper protruding in a radial direction, and the first and second hydraulic control systems may be provided at contact surfaces thereof with a first catching groove and a second catching groove formed to extend the first bores and the second bores, respectively, such that the first catching groove and the second catching groove correspond to each other, the first catching groove and the second catching groove constituting a depression into which the stopper is inserted when the first and second hydraulic control systems are coupled to each other.

The channel connection seal may have elastic force, may be manufactured by injection molding, and may be formed in a lip-type shape to resist internal pressure.

In another embodiment, the channel connection seal may be provided at the outer circumference of the first coupling part or the second coupling part thereof with a groove, in which a sealing member and a backup ring are fitted, and the channel connection seal may include a metallic main body constituted by the first coupling part and the second coupling part which are integrally formed.

The first hydraulic control system may be connected to a brake pedal of a vehicle, and the second hydraulic control system may be connected to wheel cylinders mounted to wheels of the vehicle to control brake hydraulic pressure supplied to the wheel cylinders.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically showing the construction of a conventional integrated hydraulic control system;

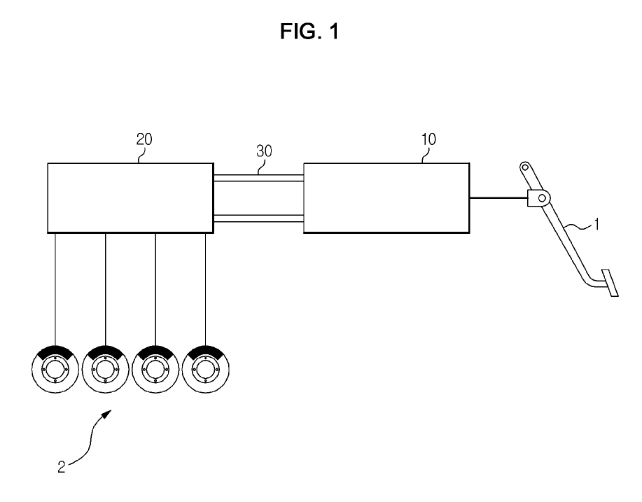

FIG. 2 is a sectional view showing a hydraulic control system connection structure of the conventional integrated hydraulic control system;

FIG. 3 is a view schematically showing the construction of an integrated hydraulic control system according to an embodiment of the present invention;

FIG. 4 is an exploded sectional view showing a state in which integrated hydraulic control systems of the integrated hydraulic control system according to the embodiment of the present invention are coupled to each other by a sealing structure;

FIG. 5 is an assembled sectional view of FIG. 4; and

FIG. 6 is a sectional view showing a state in which integrated hydraulic control systems of an integrated hydraulic control system according to another embodiment of the present invention are coupled to each other by a sealing structure.

### DETAILED DESCRIPTION

Reference will now be made in detail to the embodiments of the present invention, examples of which are illustrated in the accompanying drawings, wherein like reference numerals refer to like elements throughout. First of all, terminology used in this specification and claims must not be construed as limited to the general or dictionary meanings thereof and should be interpreted as having meanings and concepts matching the technical idea of the present invention based on the principle that an inventor is able to appropriately define the concepts of the terminologies to describe the invention in the best way possible. The embodiment disclosed herein and configurations shown in the accompanying drawings are only one preferred embodiment and do not represent the full technical idea of the present invention. Therefore, it is to be understood that the present invention covers the modifications and variations of this invention provided they come within the scope of the appended claims and their equivalents when this application was filed.

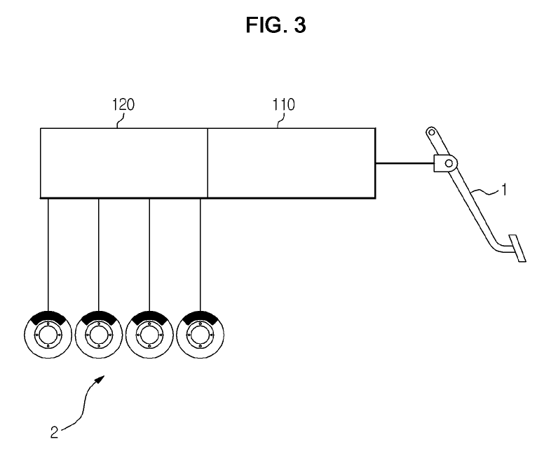

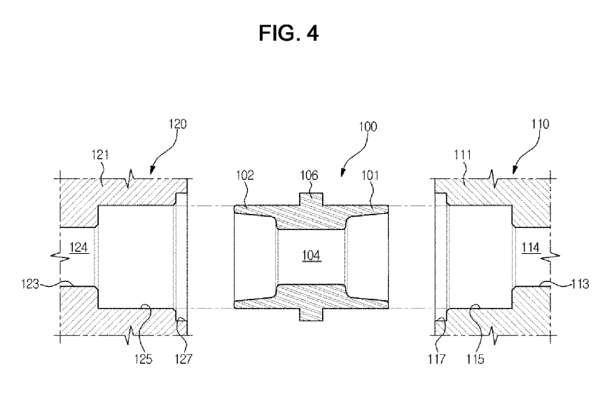

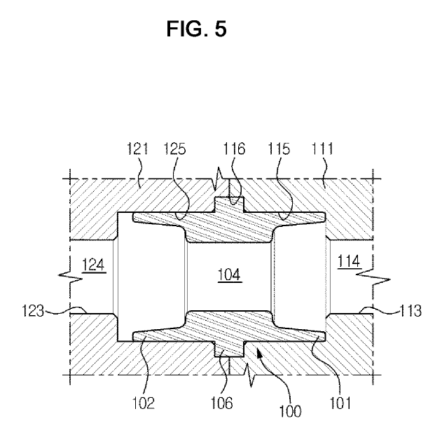

FIG. 3 is a view schematically showing the construction of an integrated hydraulic control system according to an embodiment of the present invention, FIG. 4 is an exploded sectional view showing a state in which integrated hydraulic control systems of the integrated hydraulic control system according to the embodiment of the present invention are coupled to each other by a sealing structure, and FIG. 5 is an assembled sectional view of FIG. 4.

Referring to FIGS. 3 to 5, the integrated hydraulic control system according to the embodiment of the present invention includes a first hydraulic control system 110 connected to a brake pedal 1 to control brake hydraulic pressure, a second hydraulic control system 120 coupled to the first hydraulic control system 110 to control brake hydraulic pressure supplied to wheel cylinders 2 of a vehicle, and a sealing structure provided between the first hydraulic control system 110 and the second hydraulic control system 120.

The first hydraulic control system 110 and the second hydraulic control system 120 supply or control brake hydraulic pressure generated by pedal force of the brake pedal 1 to the wheel cylinders 2. As previously described, an electronic control brake system, such as an anti-lock brake system (ABS), a brake traction control system (BTCS), a vehicle dynamic control system (VDC) or electronic stability control (ESC), an active hydraulic booster (AHB), an electro hydraulic brake system (EHB), or a hydraulic power unit (HPU), may be used as the first and second hydraulic control systems 110 and 120.

Meanwhile, since the first hydraulic control system 110 is connected to the brake pedal 1, the first hydraulic control system 110 may be adopted as a master cylinder in which brake hydraulic pressure is initially generated by pedal force of the brake pedal 1 in addition to the above-mentioned electronic control brake systems. Of course, a master cylinder (not shown) may be provided between the first hydraulic control system 110 and the brake pedal 1. Hereinafter, the first hydraulic control system 110 will be described as one of the electronic control brake systems being adopted as the first hydraulic control system 110.

In addition, although not shown, each of the first and second hydraulic control systems 110 and 120 includes a plurality of solenoid valves mounted in each of modulator blocks 111 and 121, a pair of low-pressure and high-pressure accumulators, a motor and pump to forcibly pump oil temporarily stored in the low-pressure accumulator, and an electrical control unit (ECU) to control driving of the solenoid valves and the motor.

Since valve assemblies of the solenoid valves, the pump, and the low-pressure and high-pressure accumulators are mounted in each of the cuboidal modulator blocks 111 and 121, which are made of aluminum, hydraulic pressure lines 113 and 123 formed in the modulator blocks 111 and 121 are connected to the modulator blocks 111 and 121 to constitute a circuit to supply brake hydraulic pressure to the wheel cylinders 2.

More specifically, the first hydraulic control system 110 and the second hydraulic control system 120 includes the modulator blocks 111 and 121 in which the hydraulic pressure lines 113 and 123 are formed, respectively, and are coupled to each other in a surface contact fashion. The first and second hydraulic control systems 110 and 120 are coupled to each other such that the hydraulic pressure line 113 formed in the modulator block 111 of the first hydraulic control system 110 and the hydraulic pressure line 123 formed in the modulator block 121 of the second hydraulic control system 120 communicate with each other to form one or more through channel 114 and 124.

Hereinafter, the modulator block 111 and the hydraulic pressure line 113 of the first hydraulic control system 110 will be referred to as a first modulator block 111 and a first hydraulic pressure line 113, and the modulator block 121 and the hydraulic pressure line 123 of the second hydraulic control system 120 will be referred to as a second modulator block 121 and a second hydraulic pressure line 123.

A plurality of first bores 115 connected to the first hydraulic pressure line 113 is formed at the outside of the first modulator block 111 of the first hydraulic control system 110. The first bores 115 are formed on the through channel 114 formed by communication with the first hydraulic pressure line 113 and the second hydraulic pressure line 123 when the first hydraulic control system 110 and the second hydraulic control system 120 are coupled to each other. The through channel 114 and 124 are formed in an extended fashion. Also, a plurality of second bores 125 formed at the outside of the second modulator block 121 of the second hydraulic control system 120 has the same structure as the first bores 115.

Meanwhile, a first catching groove 117 and a second catching groove 127 are formed at contact surfaces of the first and second hydraulic control systems 110 and 120 formed to extend the first bores 115 and the second bores 125, respectively, such that the first catching groove 117 and the second catching groove 127 correspond to each other. When the first and second hydraulic control systems 110 and 120 are coupled to each other, the first catching groove 117 and the second catching groove 127 constitute a depression 116 into which a stopper 106 of a channel connection seal 100, which will be described below, is inserted.

The channel connection seal 100 is provided at the through channels 114 and 124 formed when the first and second hydraulic control systems 110 and 120 are coupled to each other to block leakage of brake hydraulic pressure outside. That is, the integrated hydraulic control system has a sealing structure from which brake hydraulic pressure is not leaked by the channel connection seal 100. Opposite ends of the channel connection seal 100 are fitted in the first and second bores 115 and 125. The channel connection seal 100 is forcibly fitted in one of the first and second bores 115 and 125. For example, the channel connection seal 100 is forcibly inserted into the first bores 115 to serve as an assembly guide when the second hydraulic control system 120 is coupled to the first hydraulic control system 110.

More specifically, the channel connection seal 100 includes a first coupling part 101 coupled to the first bores 115 and a second coupling part 102 coupled to the second bores 125. In the channel connection seal 100 is formed a hollow part 104 in the longitudinal direction. The hollow part 104 communicates with the through channels 114 and 124 in a straight line.

Meanwhile, the channel connection seal 100 is provided at the outer circumference thereof with a stopper 106, which protrudes in the radial direction to prevent the channel connection seal 100 from being moved by brake hydraulic pressure. The stopper 106 is formed at a position corresponding to the depression 116 such that the stopper 106 is inserted into the depression 116. That is, as shown in FIG. 5, the channel connection seal 100 is configured to seal the through channels 114 and 124 in a state in which the movement of the channel connection seal 100 is restricted by the stopper 106 although the channel connection seal 100 is moved by brake hydraulic pressure.

Also, the channel connection seal 100 is formed in a lip-type shape to resist internal pressure. That is, as shown, the channel connection seal 100 is formed such that a middle portion of the hollow part 104 has a less diameter than opposite ends of the hollow part 104. When internal pressure is generated in the integrated hydraulic control system, therefore, separation between the first and second hydraulic control systems 110 and 120 is easily and stably prevented.

The channel connection seal 100 may have predetermined elastic force to tightly and securely couple the first and second hydraulic control systems 110 and 120 and to prevent leakage of brake hydraulic pressure. Also, the channel connection seal 100 is manufactured by injection molding to have the lip-type shape and to be formed integrally with the stopper 106.

According to this embodiment, the channel connection seal 100 has the lip-type shape, is provided at the outer circumference thereof with the stopper 106, and is coupled to the first and second bores 115 and 125; however, embodiments of the present invention are not limited thereto. The channel connection seal 100 may be constituted by unit assemblies having predetermined stiffness.

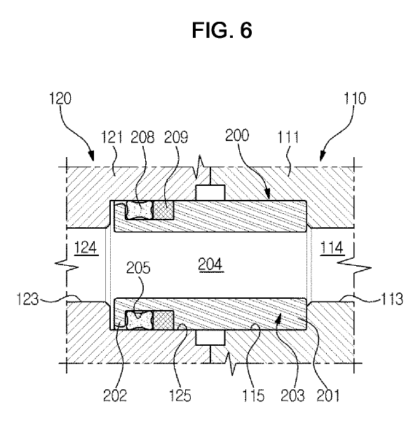

For example, as shown in FIG. 6, a sealing structure according to another embodiment of the present invention includes a channel connection seal 200 coupled to the first bores 115 formed in the first modulator block 111 of the first hydraulic control system 110 and the second bores 125 formed in the second modulator block 121 of the second hydraulic control system 120. The sealing structure according to this embodiment is identical in structure and function to the sealing structure according to the previous embodiment except that the channel connection seal 200 is different from the channel connection seal 100, and therefore, the same parts will be denoted by the same reference numerals.

The channel connection seal 200 according to this embodiment includes a metallic main body 203 constituted by a first coupling part 201 fitted in the first bores 115 and a second coupling part 202 fitted in the second bores 125. The first coupling part 201 and the second coupling part 202 are integrally formed. The channel connection seal 200 is forcibly fitted in at least one of the first and second bores 115 and 125.

In the main body 203 is formed a hollow part 204, which is formed through the main body 203 in the longitudinal direction to communicate with the through channels 114 and 124 in a straight line. Also, the main body 203 is provided at the outer circumference thereof with a groove 205 in which an 0-ring shaped sealing member 208 and a backup ring 209 are fitted. The groove 205 may be formed at the outer circumference of the first coupling part 201 or the second coupling part 202. In this embodiment, the groove 205 is formed at the outer circumference of the second coupling part 202. The first coupling part 201 is forcibly fitted in the first bores 115, and leakage of brake hydraulic pressure outside is prevented by the sealing member 208 provided at the outer circumference of the second coupling part 202.

Meanwhile, as described above, the two hydraulic control systems 110 and 120 are connected to each other using the above-mentioned channel connection seal 100 or 200; however, embodiments of the present invention are not limited thereto. For example, three or more hydraulic control systems may be connected to one another, or one hydraulic control system may be connected to a master cylinder.

Hereinafter, a state in which the hydraulic control systems are coupled to each other by the channel connection seal with the above-stated construction will be described in brief.

First, the channel connection seal 100 or 200 is forcibly inserted into the first bores 115 of the first hydraulic control system 110 connected to the brake pedal 1. At this time, the first bores 115 communicate with the first hydraulic line 113 formed in the first modulator block 111, and forms the through channels 114 and 124 when the first hydraulic control system 110 is coupled with the second hydraulic control system 120. That is, the channel connection seal 100 or 200 is coupled to one or more through channels 114 and 124, which communicate with each other, when the first hydraulic control system 110 is coupled with the second hydraulic control system 120.

Subsequently, the second hydraulic control system 120 is tightly coupled to the first hydraulic control system 110. At this time, the second hydraulic control system 120 is fixed to the first hydraulic control system 110, which is fixed to the vehicle. When the second hydraulic control system 120 is coupled to the first hydraulic control system 110, the channel connection seal 100 or 200 fixed to the first bores 115 serve as an assembly guide of the second hydraulic control system 120. Consequently, the second hydraulic control system 120 is easily coupled to the first hydraulic control system 110 by the channel connection seal 100 or 200. At this time, the channel connection seal 100 or 200 may be forcibly inserted into the second hydraulic control system 120 in the same manner as the first hydraulic control system 110.

That is, as described above, the first and second hydraulic control systems 110 and 120 are simply, tightly, and securely coupled to each other by the channel connection seal 100 or 200 without leakage of brake hydraulic pressure.

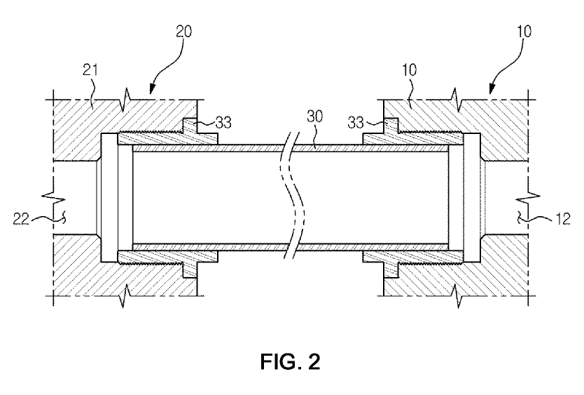

Consequently, the first and second hydraulic control systems 110 and 120 are coupled to each other using the channel connection seal 100 or 200 such that no gap between the first and second hydraulic control systems 110 and 120 is formed, and therefore, the size of the integrated hydraulic control system is greatly reduced as compared with the size of the conventional integrated hydraulic control system, thereby improving space utilization of the integrated hydraulic control system. Also, the liquid pressure pipe 30 (see FIG. 2) is not used to interconnect the hydraulic control systems 110 and 120, thereby reducing manufacturing cost and preventing the occurrence of an accident due to damage to the pipe caused by external impact.

As is apparent from the above description, in the sealing structure for the integrated hydraulic control system according to the embodiment of the present invention and the integrated hydraulic control system with the same, the hydraulic control systems are connected to each other by the sealing structure without a liquid pressure pipe to interconnect the hydraulic control systems, and therefore, the integrated hydraulic control system is configured to have a compact structure. Furthermore, space utilization of the integrated hydraulic control system is improved. Also, a liquid pressure pipe of a predetermined length is not used, thereby reducing manufacturing cost and product cost.

In addition, the hydraulic control systems may be connected to each other by a simple structure, thereby improving assembly efficiency, and electrical control units provided at the respective hydraulic control systems may be unified by integrating the hydraulic control systems.

Also, the sealing structure to connect hydraulic circuits of the hydraulic control systems may be constituted by unit assemblies.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A sealing structure for an integrated hydraulic control system to integrate a first hydraulic control system to control brake hydraulic pressure, the first hydraulic control system having a modulator block, in which the hydraulic pressure line to supply brake hydraulic pressure to wheel cylinders of a vehicle is formed, and a second hydraulic control system connected to the first hydraulic control system, wherein
the first and second hydraulic control systems are coupled to each other each other in a surface contact fashion such that the hydraulic pressure line formed in the modulator block of the first hydraulic control system communicates with a hydraulic pressure line formed in a modulator block of the second hydraulic control system to form at least one through channel, and
a hollow channel connection seal to block leakage of the brake hydraulic pressure outside is provided in the through channel.

2. The sealing structure according to claim 1, wherein the modulator blocks of the first and second hydraulic control systems, in which the through channel is formed, are provided with bores formed to extend the through channel, and the channel connection seal is forcibly fitted in the bores formed in the first hydraulic control system and/or the bores formed in the second hydraulic control system.

3. The sealing structure according to claim 1, wherein the channel connection seal is provided at an outer circumference thereof with a stopper protruding in a radial direction to prevent the channel connection seal from being moved by the brake hydraulic pressure.

4. The sealing structure according to claim 1, wherein the channel connection seal has elastic force and is manufactured by injection molding.

5. The sealing structure according to claim 1, wherein the channel connection seal is formed in a lip-type shape to resist internal pressure.

6. The sealing structure according to claim 1, wherein
the channel connection seal comprises a metallic main body having a groove formed at an outer circumference thereof, and
the sealing structure further comprises a sealing member and a backup ring fitted in the groove.

7. The sealing structure according to claim 6, wherein the sealing member and the backup ring are located in one of the modulator blocks of the first and second hydraulic control systems in a state in which the channel connection seal is coupled to the through channel.

8. An integrated hydraulic control system comprising:
a first hydraulic control system comprising a first modulator block having a first hydraulic pressure line formed therein, the first modulator block being provided at an outside thereof with a plurality of first bores connected to the first hydraulic pressure line;
a second hydraulic control system comprising a second modulator block having a second hydraulic pressure line formed therein, the second modulator block being provided at an outside thereof with a plurality of second bores connected to the second hydraulic pressure line, the second hydraulic control systems being coupled to the first hydraulic control system in a surface contact fashion such that the first hydraulic pressure line and the second hydraulic pressure line communicate with each other to form at least one through channel; and
a channel connection seal comprising a first coupling part coupled to the first bores of the first modulator block in which the through channel is formed to block leakage of brake hydraulic pressure outside and a second coupling part coupled to the second bores of the second modulator block, the channel connection seal having a hollow part formed therein in a longitudinal direction such that the hollow part communicates with the through channel, wherein
the first coupling part and/or the second coupling part of the channel connection seal is forcibly fitted in the first bores and/or the second bores.

9. The integrated hydraulic control system according to claim 8, wherein
the channel connection seal is provided at an outer circumference thereof with a stopper protruding in a radial direction, and
the first and second hydraulic control systems are provided at contact surfaces thereof with a first catching groove and a second catching groove formed to extend the first bores and the second bores, respectively, such that the first catching groove and the second catching groove correspond to each other, the first catching groove and the second catching groove constituting a depression into which the stopper is inserted when the first and second hydraulic control systems are coupled to each other.

10. The integrated hydraulic control system according to claim 9, wherein
the channel connection seal has elastic force, is manufactured by injection molding, and is formed in a lip-type shape to resist internal pressure.

11. The integrated hydraulic control system according to claim 8, wherein
the channel connection seal is provided at an outer circumference of the first coupling part or the second coupling part thereof with a groove, in which a sealing member and a backup ring are fitted, and
the channel connection seal comprises a metallic main body constituted by the first coupling part and the second coupling part which are integrally formed.

12. The integrated hydraulic control system according to claim 8, wherein the first hydraulic control system is connected to a brake pedal of a vehicle, and the second hydraulic control system is connected to wheel cylinders mounted to wheels of the vehicle to control brake hydraulic pressure supplied to the wheel cylinders.
